(19) United States
(12) Patent Application Publication
(10) Pub. No.: US 2022/0101224 A1
(43) Pub. Date: Mar. 31, 2022

(54) WORK ASSIGNMENT DEVICE, WORK ASSIGNMENT SYSTEM, AND WORK ASSIGNMENT METHOD

(71) Applicant: Mitsubishi Electric Corporation, Tokyo (JP)

(72) Inventors: Shuhei FUJITA, Tokyo (JP); Hirokazu KAIEDA, Tokyo (JP); Ai TAKAMI, Tokyo (JP)

(73) Assignee: Mitsubishi Electric Corporation, Tokyo (JP)

(21) Appl. No.: 17/426,108

(22) PCT Filed: Mar. 11, 2019
(86) PCT No.: PCT/JP2019/009691

§ 371 Date: Jul. 28, 2021

(51) Int. Cl. G06Q 10/06

(52) U.S. Cl. CPC G06Q 10/06311

(57) ABSTRACT

Appropriate work assignment is achieved in consideration of the mental and physical condition of a worker. A work assignment device includes a biometric information acquisition unit for acquiring biometric information on a living body of the worker, a production information acquisition unit for acquiring production information on a work record of the worker, a time-series data generation unit for generating time-series data associating each worker with the biometric information and the production information, a mental/physical condition estimation unit for estimating the mental and physical condition of the worker on the basis of the time-series data, and a work assignment unit for assigning a work to the worker on the basis of the estimated mental and physical condition of the worker.

### TECHNICAL FIELD

A technique disclosed in the specification of the present application relates to a work assignment device, a work assignment system, and a work assignment method.

### BACKGROUND ART

In recent years, biometric information such as a heartbeat, a pulse, or the like can be continuously acquired with high accuracy by using a low-price wearable device.

Further, a system has been developed, which estimates a mental and physical condition, such as a concentration level of a worker, a fatigue level of the worker, or the like, from the biometric information acquired by using the above-described wearable device and manages the safety, the health, or the like of the worker on the basis of the estimation result.

In such a system, since the worker does not need to be conscious that his own biometric information is measured, it is possible to manage the worker in a more natural state. Therefore, it is considered that this system should be applied to a site or the like, such as a factory or the like, which has a large site area where a plurality of persons are present at the same time.

Patent Document 1, for example, discloses a technique in which biometric information of a worker is acquired by using the above-described wearable device and the acquired biometric information is compared with a threshold value of the biometric information which is preset for each worker, to thereby estimate a concentration level indicating the degree of concentration of the worker to a work.

Patent Document 2, for example, discloses a technique in which a simulation of production process is performed by using production information of plant facilities and a bottleneck is extracted with the availability rate used as an index. In the technique disclosed in Patent Document 2, personal distribution is made in consideration of a fatigue level and the proficiency of a worker in order to optimize the personal distribution on the basis of the extraction result of the bottleneck.

According to this technique, a worker with low fatigue level and high proficiency, among workers, is allocated to a process which is the bottleneck in the production process, and it is thereby possible to ensure uniformization of work efficiency.

### PRIOR ART DOCUMENTS

### Patent Documents

[Patent Document 1] Japanese Patent Application Laid Open Gazette No. 2017-50803

[Patent Document 2] Japanese Patent Application Laid Open Gazette No. 2007-79768

### SUMMARY

### Problem to be Solved by the Invention

In the technique disclosed in Patent Document 1, however, only the biometric information is used to estimate the concentration level of the worker.

In this case, since even a worker whose concentration level is estimated to be high sometimes has low work efficiency, there is a problem that a manager has difficulty in making appropriate personal distribution.

Further, in the technique disclosed in Patent Document 2, any biometric information of the worker is not acquired by using the wearable device or the like and a set value indicating the mental and physical condition, which is prepared in advance, is used to make the personal distribution. For this reason, there is a problem that a worker with high fatigue level is sometimes allocated to the bottleneck process disadvantageously.

A technique disclosed in the specification of the present application is intended to solve the above-described problems, and it is an object of the present invention to provide a technique of achieving appropriate work assignment in consideration of a mental and physical condition of a worker.

### Means to Solve the Problem

A work assignment device according to a first aspect of the technique disclosed in the specification of the present application includes a biometric information acquisition unit for acquiring biometric information on a living body of a worker, a production information acquisition unit for acquiring production information on a work record of the worker, a time-series data generation unit for generating time-series data associating each worker with the biometric information and the production information, a mental/physical condition estimation unit for estimating a mental and physical condition of the worker on the basis of the time-series data, and a work assignment unit for assigning a work to the worker on the basis of the estimated mental and physical condition of the worker.

A work assignment system according to a second aspect of the technique disclosed in the specification of the present application includes the above-described work assignment device, and a temporal change estimation unit for estimating a temporal change in the mental and physical condition of the worker on the basis of the estimated mental and physical condition of the worker, and in the work assignment system, the work assignment unit assigns a work to the worker on the basis of the estimated mental and physical condition of the worker and the estimated temporal change in the mental and physical condition of the worker.

A work assignment method according to a third aspect of the technique disclosed in the specification of the present application includes generating time-series data associating each worker with biometric information on a living body of a worker and production information on a work record of the worker, estimating a mental and physical condition of the worker on the basis of the time-series data, and assigning a work to the worker on the basis of the estimated mental and physical condition of the worker.

### Effects of the Invention

The work assignment device according to a first aspect of the technique disclosed in the specification of the present application includes a biometric information acquisition unit for acquiring biometric information on a living body of a worker, a production information acquisition unit for acquiring production information on a work record of the worker, a time-series data generation unit for generating time-series data associating each worker with the biometric information and the production information, a mental/physical condition estimation unit for estimating a mental and physical condition of the worker on the basis of the time-series data, and a work assignment unit for assigning a work to the worker on the basis of the estimated mental and physical condition of the worker. According to such a configuration, the effective mental and physical condition of the worker can be estimated in consideration of the biometric information of the worker and the production information on the work record of the worker, and further, a work can be assigned to the worker on the basis of the mental and physical condition of the worker, which is estimated thus. Therefore, it is possible to uniformize the work as compared with the case where the work is assigned to the worker on the basis of the mental and physical condition estimated only from the biometric information, and to achieve appropriate personal distribution.

The work assignment system according to a second aspect of the technique disclosed in the specification of the present application includes the above-described work assignment device, and a temporal change estimation unit for estimating a temporal change in the mental and physical condition of the worker on the basis of the estimated mental and physical condition of the worker, and in the work assignment system, the work assignment unit assigns a work to the worker on the basis of the estimated mental and physical condition of the worker and the estimated temporal change in the mental and physical condition of the worker. According to such a configuration, since the temporal change in the mental and physical condition of the worker is estimated, the change in the mental and physical condition of the worker, which may be caused by continuation of the work, can be reflected on the work assignment.

The work assignment method according to a third aspect of the technique disclosed in the specification of the present application includes generating time-series data associating each worker with biometric information on a living body of a worker and production information on a work record of the worker, estimating a mental and physical condition of the worker on the basis of the time-series data, and assigning a work to the worker on the basis of the estimated mental and physical condition of the worker. According to such a method, the effective mental and physical condition of the worker can be estimated in consideration of the biometric information of the worker and the production information on the work record of the worker, and further a work can be assigned to the worker on the basis of the mental and physical condition of the worker, which is estimated thus. Therefore, it is possible to uniformize the work as compared with the case where the work is assigned to the worker on the basis of the mental and physical condition estimated only from the biometric information, and to achieve appropriate personal distribution.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram further specifically showing an exemplary configuration of a work assignment device in accordance with a preferred embodiment;

FIG. 2 is a diagram showing an example of biometric information acquired by a wearable device that a worker wears;

FIG. 3 is a diagram showing an example of production information acquired by a production information acquisition unit corresponding to each production process;

FIG. 4 is a diagram showing an example of time-series data generated by a various information coordination unit;

FIG. 5 is a flowchart showing an exemplary procedure for estimating a mental and physical condition of the worker by using a mental/physical condition estimation unit;

FIG. 6 is a table showing an exemplary relation between each of the mental and physical conditions and weighting of the biometric information to be used for estimating the mental and physical condition;

FIG. 7 is a diagram showing an exemplary threshold value to be used for comparison with the production information;

FIG. 8 is a table showing an average value of the production information depending on the proficiency of the worker;

FIG. 9 is a graph showing an image of comparing the production information estimated from the biometric information acquired in Step ST501 with the production information acquired in Step ST501;

FIG. 10 is another graph showing an image of comparing the production information estimated from the biometric information acquired in Step ST501 with the production information acquired in Step ST501;

FIG. 11 is a diagram showing an exemplary effective concentration level of the worker, which is estimated by the mental/physical condition estimation unit;

FIG. 12 is a table showing an example of information on the effective concentration level required for each work;

FIG. 13 is a table showing an example of information on the mental and physical condition of the worker, which is required for each work;

FIG. 14 is a diagram schematically showing an exemplary hardware configuration in a case where the work assignment device in accordance with the preferred embodiment is actually operated;

FIG. 15 is a diagram showing an exemplary network configuration of the work assignment device in accordance with the preferred embodiment;

FIG. 16 is a diagram showing an example of dynamic state information of the worker, which is acquired by a biometric information acquisition unit;

FIG. 17 is a graph showing an exemplary case where determination on whether or not the worker is working is performed by using three-axis acceleration acquired from the worker;

FIG. 18 is a flowchart showing an exemplary procedure for estimating the mental and physical condition of the worker by using the mental/physical condition estimation unit;

FIG. 19 is a diagram showing an exemplary result obtained by performing noise determination of the biometric information and the production information by using the dynamic state information of the worker;

FIG. 20 is a diagram conceptually showing an exemplary configuration of the work assignment device and an exemplary configuration of a work assignment system including a skill map generation device in accordance with the preferred embodiment;

FIG. 21 is a diagram showing an example of temporal change information of the mental and physical condition of the worker, which is generated by a skill map generation unit; and

FIG. 22 is a diagram conceptually showing an exemplary configuration of the work assignment device in accordance with the preferred embodiment.

### DESCRIPTION OF EMBODIMENT(S)

Hereinafter, the preferred embodiments will be described with reference to attached figures. In the preferred embodiments described below, though detailed features and the like will be shown for description of the technique, these are illustratively shown and all the features are not always necessary in order for the preferred embodiments to be achieved. Further, exemplary effects produced by the respective preferred embodiments will be collectively described after all the preferred embodiments are described.

Furthermore, figures are schematically shown, and for convenience of illustration, omission of some constituent elements or simplification of a structure will be made in the figures as appropriate. Further, the correlation in the size and position of a structure or the like shown in different figures is not always represented accurately but may be changed as appropriate. Even in figures other than a cross section, such as a plan view or the like, hatching is made in some cases for easy understanding of the contents in the preferred embodiments.

Further, in the following description, identical constituent elements are represented by the same reference signs and each have the same name and function. Therefore, detailed description thereof will be omitted in some cases for avoiding duplication.

Furthermore, in the following description, the expression for being equal such as “identical”, “equal”, “uniform”, “homogeneous”, or the like includes a case of indicating a state being exactly equal and another case of indicating a state having a difference within a range of tolerance or where similar functions can be gained, unless otherwise noted.

Further, in the following description, when there is a description that something “comprises”, “includes”, “has”, or the like a constituent element, this description is not such an exclusive expression as indicating that there is no other constituent element, unless otherwise noted.

Furthermore, in the following description, even in a case of using ordinal numbers such as “first”, “second”, and the like, these words are used for convenience to easily understand the contents of the preferred embodiments, and the contents are not limited to the order or the like which is represented by these ordinal numbers.

<Conceptual Configuration of Work Assignment Device>

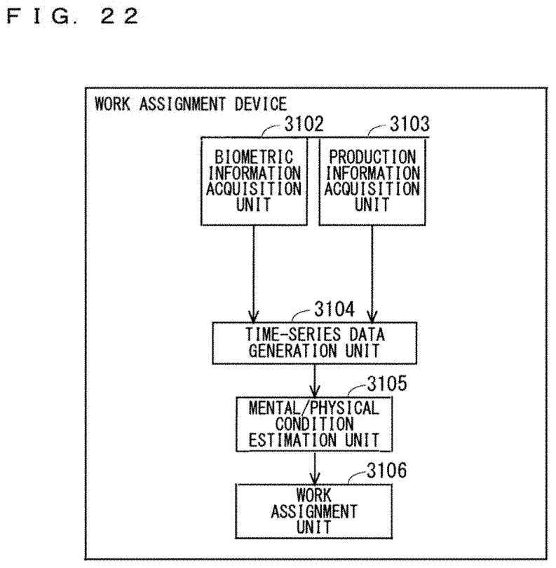

FIG. 22 is a diagram conceptually showing an exemplary configuration of a work assignment device in accordance with the present preferred embodiment.

As exemplarily shown in FIG. 22, the work assignment device includes a biometric information acquisition unit 3102 for acquiring biometric information on a living body of a worker, a production information acquisition unit 3103 for acquiring production information on a work record of the worker, a time-series data generation unit 3104 for generating time-series data associating each worker with the biometric information and the production information, a mental/physical condition estimation unit 3105 for estimating a mental and physical condition of the worker on the basis of the time-series data, and a work assignment unit 3106 for assigning a work to the worker on the basis of the estimated mental and physical condition of the worker.

### The First Preferred Embodiment

Hereinafter, a work assignment device and a work assignment method in accordance with the present preferred embodiment will be described.

<Configuration of Work Assignment Device>

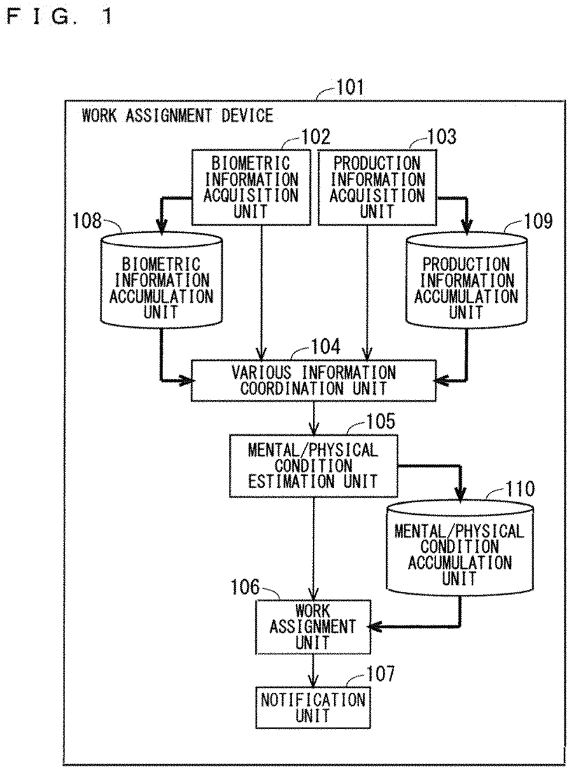

FIG. 1 is a diagram further specifically showing an exemplary configuration of a work assignment device in accordance with the present preferred embodiment.

As exemplarily shown in FIG. 1, a work assignment device 101 includes a biometric information acquisition unit 102, a production information acquisition unit 103, a various information coordination unit 104, a mental/physical condition estimation unit 105, a work assignment unit 106, a notification unit 107, a biometric information accumulation unit 108, a production information accumulation unit 109, and a mental/physical condition accumulation unit 110.

The biometric information acquisition unit 102 in the configuration of FIG. 1 is, for example, a wearable device that is wearable on a body of a worker who is doing a work in a factory, a plant, a construction site, or the like. The biometric information acquisition unit 102 transmits acquired biometric information to the biometric information accumulation unit 108.

Hereinafter, an exemplary case where a worker at a factory is a target to be measured will be described. Further, since there is a case where one worker wears and uses a plurality of wearable devices, the work assignment device 101 exemplarily shown in FIG. 1 can afford to include the biometric information acquisition units 102 whose number is as many as or more than the number of workers serving as the targets to be measured.

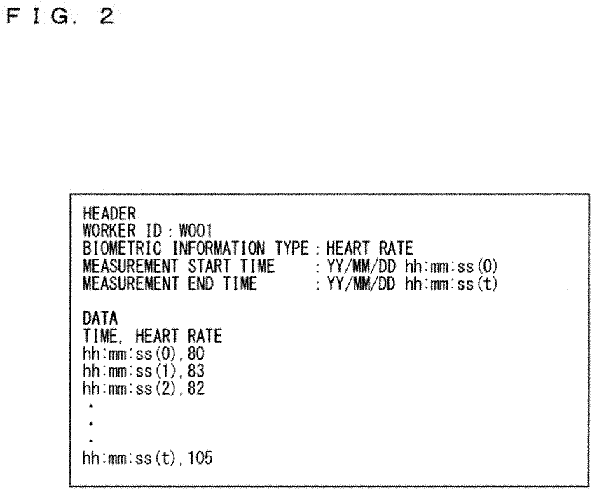

FIG. 2 is a diagram showing an example of the biometric information acquired by the wearable device that the worker wears.

Herein, the biometric information is time-series data such as a heart rate (cardiac cycle), a pulse rate, a nictation rate, an ocular potential, a line of sight, a body surface temperature, a core body temperature, a blood pressure, a respiration rate, a sweat rate, a skin potential, or the like of the worker, which is acquired by the wearable device.

In the biometric information, stored are a header part including a worker ID unique to each worker, a biometric information type indicating the type of the acquired biometric information (the heart rate in FIG. 2), a measurement start time indicating the start date and time of the measurement, a measurement end time indicating the end date and time of the measurement, and the like and a data part including numerical information of the acquired biometric information (a measured value: the heart rate at each time in FIG. 2) and the like.

Though the measured value is an integer value in the exemplary case of FIG. 2, the measured value may be a real value, and depends on the specification of the wearable device.

Further, time information of each measured value has only to specify the time when each measured value is acquired. If the cycle in which the wearable device acquires the biometric information from the worker is constant, for example, the time of the measured value can be specified by writing cycle information into the header part. In this case, the time information of the measured value can be omitted from the biometric information.

The production information acquisition unit 103 in the configuration of FIG. 1 is installed corresponding to each production process inside the factory. The production information acquisition unit 103 acquires production information which is information on a work record of the worker and further transmits the acquired production information to the production information accumulation unit 109. Furthermore, since the production information acquisition unit 103 acquires the production information for each production process, the work assignment device 101 shown in FIG. 1 can afford to include the production information acquisition units 103 corresponding to the number of production processes.

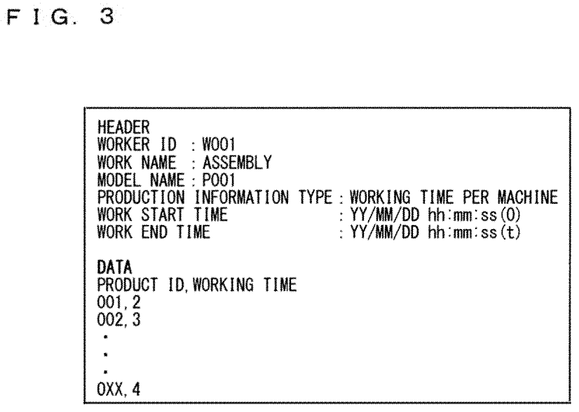

FIG. 3 is a diagram showing an example of the production information acquired by the production information acquisition unit corresponding to each production process.

Herein, the production information is time-series data on the work record such as a target work name, the cumulative number of works (working machines), the average number of works (working machines) per given time, an average working time per machine, the number of reworks, a defect rate, or the like.

In the production information, stored are a header part including the worker ID unique to each worker, a work name indicating the specifics of the work (an assembly work in FIG. 3), a model name indicating a machine model which is operating, a production information type indicating the type of the acquired production information (a working time per machine in FIG. 3), a work start time indicating the start date and time of the work, a work end time indicating the end date and time of the work, and the like and a data part including a product ID for specifying a product one by one, numerical information of the production information (a working time corresponding to the product ID in FIG. 3), and the like.

Further, since there is a case where a plurality of types of machine models are used for one production process, the model name recorded as the header part may be recorded as the data part.

The biometric information accumulation unit 108 in the configuration of FIG. 1 accumulates the biometric information acquired by the biometric information acquisition unit 102. Further, the biometric information accumulation unit 108 transmits the biometric information to the various information coordination unit 104 in a cycle which is set by a manager in advance.

The production information accumulation unit 109 in the configuration of FIG. 1 accumulates the production information acquired by the production information acquisition unit 103. Further, the production information accumulation unit 109 transmits the production information to the various information coordination unit 104 in a cycle which is set by the manager in advance.

The various information coordination unit 104 in the configuration of FIG. 1 acquires the time-series data accumulated in the biometric information accumulation unit 108 and the production information accumulation unit 109 in a cycle and with the amount of data which are set by the manager in advance. Then, the various information coordination unit 104 generates new time-series data associated with the worker ID by using the respective types of information (i.e., the biometric information and the production information).

The various information coordination unit 104 acquires, for example, the time-series data of the most recent 30 minutes every one minute. Then, the various information coordination unit 104 generates new time-series data by using the biometric information and the production information which are acquired and transmits the time-series data to the mental/physical condition estimation unit 105.

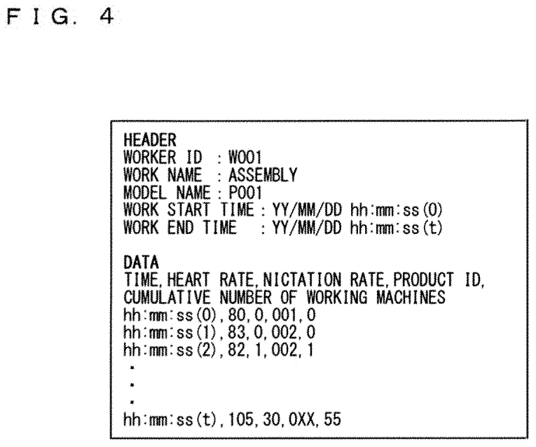

FIG. 4 is a diagram showing an example of the time-series data generated by the various information coordination unit 104.

In the exemplary case of FIG. 4, in the data part, the heart rate and the nictation rate are acquired as the biometric information from the biometric information accumulation unit 108, and the product ID and the cumulative number of working machines are acquired as the production information of the plant facilities from the production information accumulation unit 109.

Further, when new time-series data is generated by the various information coordination unit 104, there is a possibility that there may occur a difference among the respective pieces of time information of the plurality of biometric information acquisition units 102. At that time, the effect caused by the difference in the time information can be reduced by, for example, a method of regularly generating noise data, another method of making the worker do the same operation, or the like.

The mental/physical condition estimation unit 105 in the configuration of FIG. 1 estimates a mental and physical condition of the worker by using the time-series data generated by the various information coordination unit 104. Further, the mental/physical condition estimation unit 105 transmits the estimated mental and physical condition of the worker to the mental/physical condition accumulation unit 110 as the time-series data.

Herein, the mental and physical condition of the worker includes a concentration level of the worker to the work, a fatigue level of the worker, a stress level of the worker, sleepiness of the worker, or the like.

The mental/physical condition estimation unit 105 estimates the mental and physical condition of the worker by using the time-series data generated occasionally by the various information coordination unit 104 even while the worker is working.

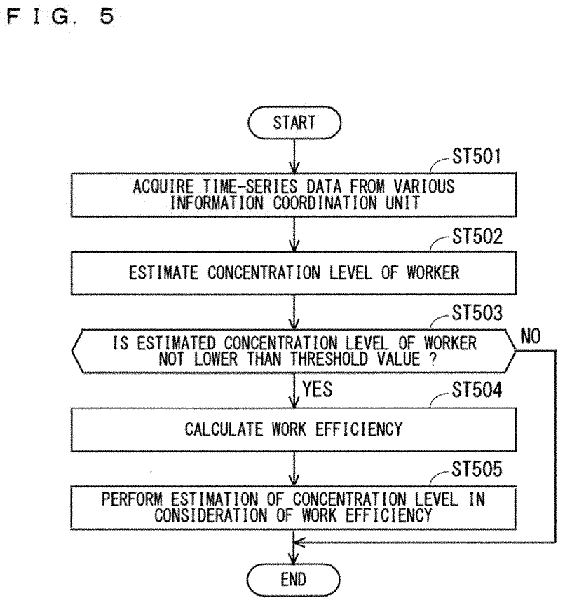

FIG. 5 is a flowchart showing an exemplary procedure for estimating the mental and physical condition of the worker by using the mental/physical condition estimation unit 105. Hereinafter, an exemplary case where the concentration level of the worker is a target to be estimated as the mental and physical condition will be described.

First, the mental/physical condition estimation unit 105 acquires, for example, the biometric information and the production information which are the time-series data, from the various information coordination unit 104, as exemplarily shown in FIG. 4 (Step ST501).

It is assumed herein that the cycle and the amount of data in/with which the mental/physical condition estimation unit 105 acquires the above-described time-series data are the same as those in/with which the various information coordination unit 104 acquires the time-series data from the biometric information accumulation unit 108 and the production information accumulation unit 109.

In a case, for example, where the manager sets that the various information coordination unit 104 acquires the time-series data from the biometric information accumulation unit 108 and the production information accumulation unit 109 in a cycle of one minute with the amount of data corresponding to the most recent 30 minutes, the mental/physical condition estimation unit 105 acquires the biometric information and the production information of the most recent 30 minutes every one minute from the various information coordination unit 104. Then, the mental/physical condition estimation unit 105 estimates the mental and physical condition of the worker by using the biometric information and the production information which are acquired and further the temporal change in these pieces of information.

Specifically, the mental/physical condition estimation unit 105 estimates the concentration level of the worker by using only the biometric information among the acquired biometric information and production information (Step ST502).

As a method of estimating the concentration level of the worker, for example, there is a possible method in which the biometric information of the worker at a normal time is held as a reference value, and an average value of the biometric information acquired in Step ST501 is compared with the reference value, to thereby express the degree of concentration (concentration level) of the worker in numerical form (for example, in numbers from 1 to 10).

Though the biometric information of the worker at a normal time is accumulated in the biometric information accumulation unit 108 and directly acquired by the mental/physical condition estimation unit 105 from the biometric information accumulation unit 108 in the above-described method, the biometric information of the worker at a normal time may be added when the biometric information is transmitted from the biometric information accumulation unit 108 to the various information coordination unit 104.

Further, when the mental/physical condition estimation unit 105 estimates the mental and physical condition, weighting may be performed on the biometric information which may affect the mental and physical condition of the target worker, to perform the estimation. In other words, it is not always necessary to compare all the acquired biometric information with the reference value.

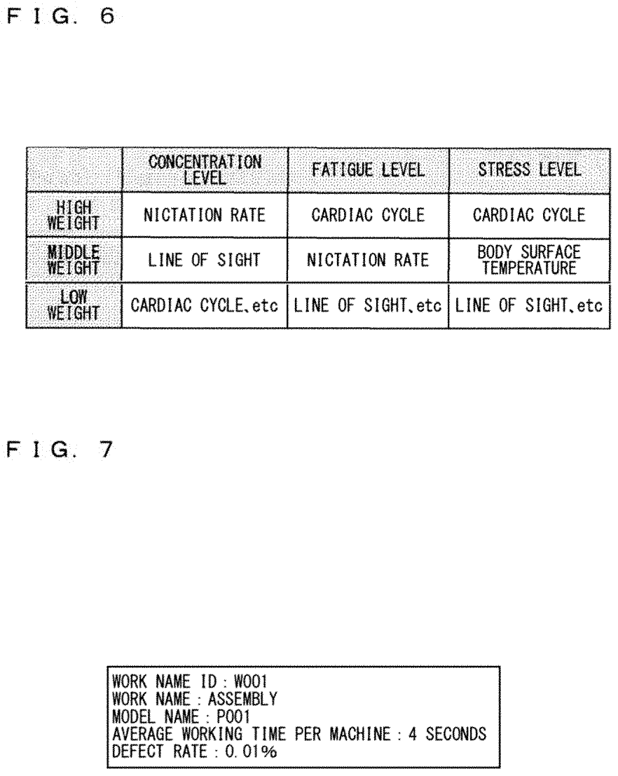

FIG. 6 is a table showing an exemplary relation between each of the mental and physical conditions and weighting of the biometric information to be used for estimating the mental and physical condition.

As exemplarily shown in FIG. 6, there may be a case where for estimation of the concentration level, for example, a large weight is given to the nictation rate among the biometric information, a middle weight is given to the line of sight, and a small weight is given to the cardiac cycle or the like.

Further, there may be another case where for estimation of the fatigue level, for example, a large weight is given to the cardiac cycle among the biometric information, a middle weight is given to the nictation rate, and a small weight is given to the line of sight or the like.

Furthermore, there may be still another case where for estimation of the stress level, for example, a large weight is given to the cardiac cycle among the biometric information, a middle weight is given to the body surface temperature, and a small weight is given to the line of sight or the like.

Next, the mental/physical condition estimation unit 105 determines whether or not the estimated concentration level of the worker is not lower than a threshold value (Step ST503). In other words, practically, the mental/physical condition estimation unit 105 determines whether or not the biometric information indicates the threshold value or more.

In a case, for example, where the threshold value is assumed to be “5” which is the concentration level at a normal time and the estimated concentration level of the worker is not lower than this threshold value, in other words, where this situation corresponds to “YES” branching from Step ST503 exemplarily shown in FIG. 5, it is determined that the concentration level of the worker is high, and the process goes to Step ST504.

On the other hand, when the estimated concentration level of the worker is lower than this threshold value, in other words, when this situation corresponds to “NO” branching from Step ST503 exemplarily shown in FIG. 5, it is determined that the concentration level of the worker is low. Then, the mental/physical condition estimation unit 105 transmits the estimated concentration level of the worker to the mental/physical condition accumulation unit 110, and this operation is ended.

Next, in Step ST504, the mental/physical condition estimation unit 105 calculates work efficiency (for example, to be expressed in numbers from 1 to 10) by comparing the production information of the work that the worker is doing with a threshold value.

Herein. as the threshold value with which the production information is compared, for example, used is an average value of the production information of the target worker of the most recent one week in the same work.

FIG. 7 is a diagram showing an exemplary threshold value to be used for comparison with the production information. In above-described Step ST504, for example, the average working time per machine (4 seconds in FIG. 7), the defect rate (0.01% in FIG. 7), or the like among the production information as shown in FIG. 7 is compared with the production information acquired in Step ST501. Then, current work efficiency is determined.

Specifically, as the average working time acquired in Step ST501 becomes shorter than that shown in FIG. 7, the work efficiency becomes higher, and as the defect rate acquired in Step ST501 becomes lower than that shown in FIG. 7, the work efficiency becomes higher.

Herein, though the production information of the most recent one week is accumulated in the production information accumulation unit 109 and directly acquired by the mental/physical condition estimation unit 105 from the production information accumulation unit 109, the production information of the most recent one week may be added when the production information is transmitted from the production information accumulation unit 109 to the various information coordination unit 104.

Further, when there is no production information of the work in which the worker is currently engaged within the most recent one week, due to a change in the specifics of the work in which the worker is engaged or the like, the production information for five days in total may be prepared by using the production information in the past earlier than the most recent one week. Further, a threshold value may be set on the basis of the production information of the most recent one day or the most recent one time, instead of five days.

In such a case, however, since there is a possibility that a case where a poor physical condition or the like in doing the work of the most recent one time causes large reduction in the work efficiency or the like case may produce a large effect, it is preferable that the production information of the most recent two days or the most recent two times at least should be used as the threshold value.

Further, when there is no production information of the worker in the past for the reason that the worker does the work for the first time or the like reason, the work efficiency may be determined from the proficiency of the worker.

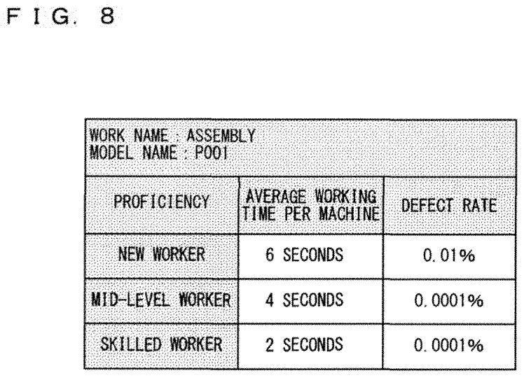

FIG. 8 is a table showing an average value of the production information depending on the proficiency of the worker. By comparison with the average value of the production information depending on the proficiency as shown in FIG. 8 on the basis of the proficiency of the worker whose mental and physical condition is a target to be estimated, the work efficiency can be calculated.

In the exemplary case of FIG. 8, the average working time per machine of a new worker is six seconds and the defect rate thereof is 0.01%, the average working time per machine of a mid-level worker is four seconds and the defect rate thereof is 0.0001%, and the average working time per machine of a skilled worker is two seconds and the defect rate thereof is 0.0001%.

Further, as another method of calculating the work efficiency, there is also a method in which the production information estimated from the biometric information acquired in above-described Step ST501 is compared with the production information acquired in above-described Step ST501, instead of using the average value of the production information of the most recent one week or the average value of the production information based on the proficiency.

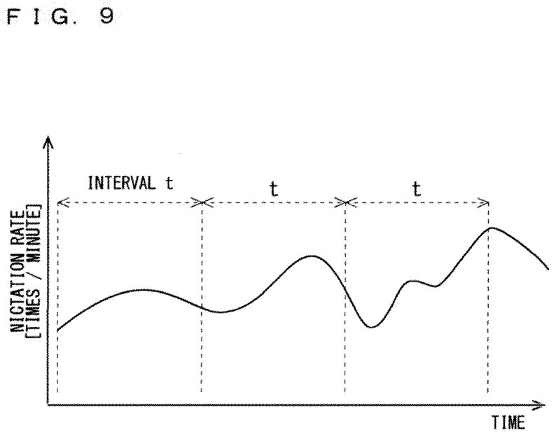

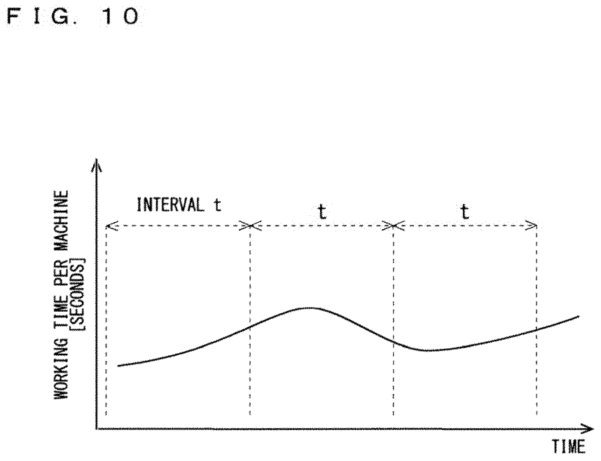

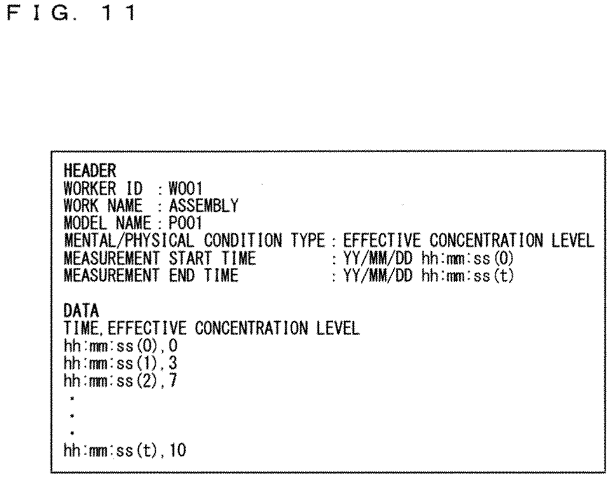

FIGS. 9 and 10 are graphs each showing an image of comparing the production information estimated from the biometric information acquired in Step ST501 with the production information acquired in Step ST501. Further, in FIGS. 9 and 10, shown is an exemplary case where the average working time per machine is estimated by using the nictation rate as the biometric information.

Herein, in FIG. 9, the vertical axis indicates the nictation rate [times/minute] and the horizontal axis indicates the time. Further, in FIG. 10, the vertical axis indicates the average working time per machine [seconds] and the horizontal axis indicates the time.

First, by using FIG. 9, calculated are an average value, a maximum value, and a minimum value of the nictation rate within a certain time interval t on the basis of the past biometric information of the worker who is engaged in the work.

Next, by using FIG. 10, calculated is the average working time per machine within the certain time interval t on the basis of the past production information of the worker.

Next, by using a relation among these data, constructed is a model f for calculating the average working time per machine from the average value, the maximum value, and the minimum value of the nictation rate. Further, the model f is expressed as the following equation (1).

P(average working time per machine)=f(average value of nictation rate,maximum value of nictation rate,minimum value of nictation rate) (1)

Finally, by using the model f, estimated is the average working time per machine from the nictation rate acquired in Step ST501.

Further, the work efficiency may be calculated by comparison with the production information acquired in Step ST501 with an estimated value of the present model f as a reference.

Furthermore, though the model f is constructed by using the nictation rate in the exemplary case of FIGS. 9 and 10, the model may be constructed by using any other biometric information, or by combining a plurality of pieces of biometric information.

Next, the mental/physical condition estimation unit 105 performs an estimation of the concentration level (hereinafter, an effective concentration level) in consideration of the work efficiency of the worker (Step ST505). As the method of estimating the effective concentration level, for example, there is a possible method in which an average value of the concentration level expressed on a scale of one to ten and the work efficiency similarly expressed on a scale of one to ten is calculated.

Thus, with the mental/physical condition estimation unit 105, it becomes possible to estimate the mental and physical condition (for example, the effective concentration level) in consideration of the work efficiency. Therefore, even in a case where a worker whose concentration level is estimated to be high on the basis of only the biometric information actually has bad work efficiency, it is possible to estimate the concentration level (effective concentration level) in consideration of the work efficiency of the worker.

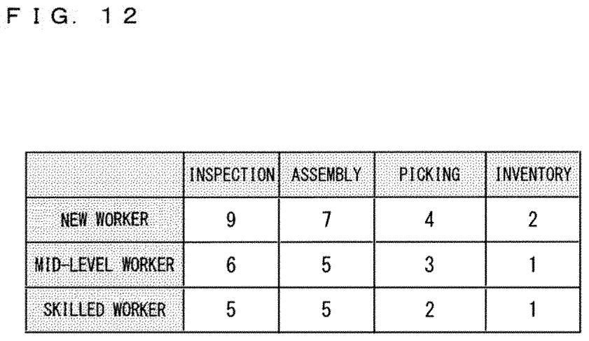

FIG. 11 is a diagram showing an exemplary effective concentration level of the worker, which is estimated by the mental/physical condition estimation unit 105.

In the exemplary case of FIG. 11, in the header part, the mental/physical condition type is the “effective concentration level”, and the measurement start time and the measurement end time are shown. Further, in the data part, the effective concentration level at each time is shown in numerical form.

The mental/physical condition accumulation unit 110 in the configuration of FIG. 1 accumulates the time-series data of the mental and physical condition of the worker (specifically, the mental and physical condition of the worker in consideration of the work efficiency), which is estimated by the mental/physical condition estimation unit 105. Further, the mental/physical condition accumulation unit 110 transmits the time-series data to the work assignment unit 106.

The work assignment unit 106 in the configuration of FIG. 1 acquires the time-series data of the most recent mental and physical condition of the worker, which is accumulated in the mental/physical condition accumulation unit 110. Then, the work assignment unit 106 generates work assignment information for ensuring an improvement in the work efficiency of the worker.

At that time, the work assignment unit 106 uses the information on the effective concentration level required for each work, as a threshold value. Further, the effective concentration level required for each work is set depending on the proficiency of the worker.

Though this information is accumulated in the production information accumulation unit 109, the information may be accumulated in any other computer terminal.

Further, the cycle in which the work assignment unit 106 acquires the data from the mental/physical condition accumulation unit 110 is set by the manager in advance. Then, when the cycle of acquiring the data is 30 minutes, for example, the work assignment unit 106 can generate the work assignment information every 30 minutes.

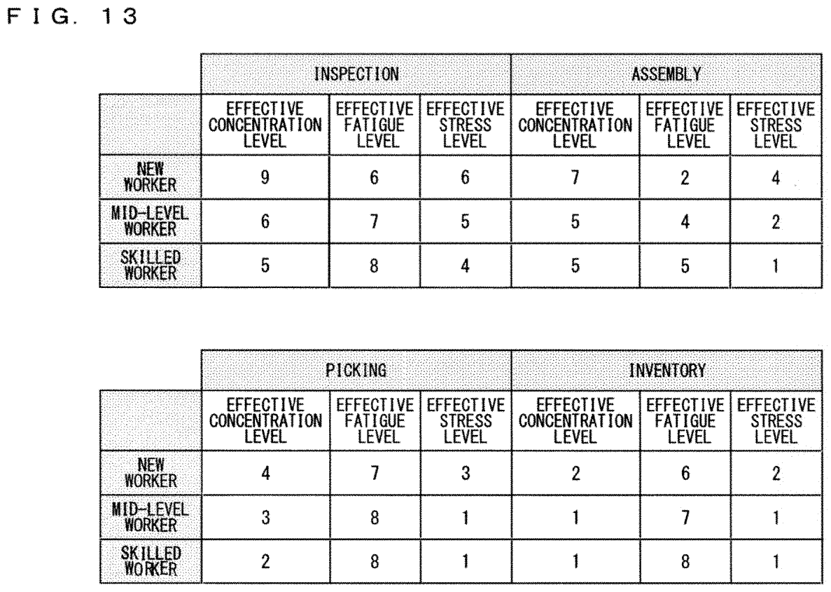

FIG. 12 is a table showing an example of information on the effective concentration level required for each work. Further, the effective concentration level required for each work is set depending on the proficiency of the worker. Furthermore, as to the effective concentration level required for each work, as the numerical value becomes larger, higher concentration is required.

In FIG. 12, for an inspection work, it is shown that the new worker needs the effective concentration level of “9”, the mid-level worker needs the effective concentration level of “6”, and the skilled worker needs the effective concentration level of “5”. For an assembly work, it is shown that the new worker needs the effective concentration level of “7”, the mid-level worker needs the effective concentration level of “5”, and the skilled worker needs the effective concentration level of “5”. Further, for a picking work, it is shown that the new worker needs the effective concentration level of “4”, the mid-level worker needs the effective concentration level of “3”, and the skilled worker needs the effective concentration level of “2”. Furthermore, for an inventory work, it is shown that the new worker needs the effective concentration level of “2”, the mid-level worker needs the effective concentration level of “1”, and the skilled worker needs the effective concentration level of “1”.

When the time-series data of the most recent mental and physical condition of the worker (for example, the effective concentration level of the worker) acquired from the mental/physical condition accumulation unit 110 does not satisfy the condition of the effective concentration level required for the current work (in other word, the current effective concentration level of the worker is lower than the required effective concentration level), the work assignment unit 106 generates the work assignment information for changing the specifics of the work of the worker to a work in which the required effective concentration level is not higher than the current effective concentration level of the worker and the required effective concentration level is closest to the current effective concentration level of the worker.

In a case, for example, where the effective concentration level of a new worker A who is doing the assembly work is determined to be “3”, since the condition of the effective concentration level of the new worker which is required for this work is not lower than “7”, the work assignment unit 106 generates the work assignment information for changing the specifics of the work of the new worker A.

As a change destination work in this work assignment information, it is determined that the inventory work (in which the condition of the required effective concentration level is not lower than “2”) in which the condition of the required effective concentration level is not higher than “3” and the required effective concentration level is closest to “3”, should be appropriate.

Further, when the effective concentration level of the target new worker A is low (for example, his effective concentration level is “1”) and there is no work which is a candidate of the change destination, the work assignment unit 106 may give a break instruction to recover the effective concentration level of the worker.

Furthermore, even when there is a work which is a candidate of the change destination, in a case, for example, where the effective concentration level of the target worker is lower than “3”, it may be set in advance to uniformly give the break instruction.

Further, when the effective concentration level acquired from the mental/physical condition accumulation unit 110 satisfies the condition of the effective concentration level required for a work in which the worker is currently engaged, the work assignment unit 106 generates the work assignment information for continuing this work.

Though the method of generating the work assignment information on the basis of the effective concentration level of the worker is shown in the above-described case, the work assignment information may be generated on the basis of the mental and physical condition in consideration of the work efficiency, instead of the effective concentration level of the worker.

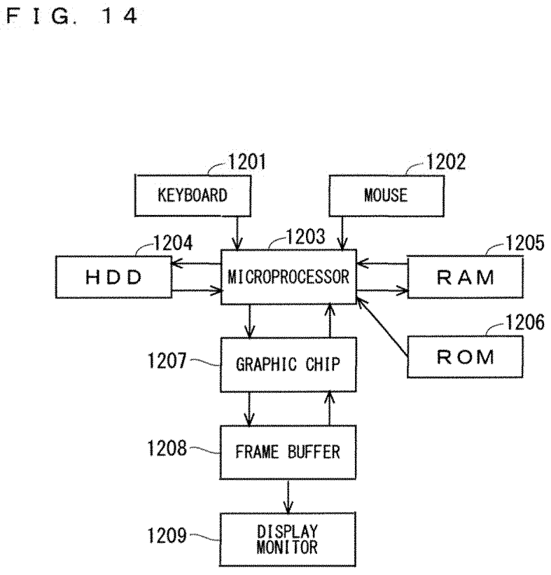

FIG. 13 is a table showing an example of information on the mental and physical condition (the effective concentration level, an effective fatigue level which is a fatigue level in consideration of the work efficiency, and an effective stress level which is a stress level in consideration of the work efficiency) of the worker, which is required for each work. Further, the effective concentration level, the effective fatigue level, and the effective stress level each of which is required for each work is set depending on the proficiency of the worker. Furthermore, as to the effective fatigue level required for each work, as the numerical value becomes smaller, a state in which less fatigue is accumulated is required. Further, as to the effective stress level required for each work, as the numerical value becomes smaller, a state in which less stress is accumulated is required.

In FIG. 13, for the inspection work, it is shown that the new worker needs the effective concentration level of “9”, the effective fatigue level of “6”, and the effective stress level of “6, the mid-level worker needs the effective concentration level of “6”, the effective fatigue level of “7”, and the effective stress level of “5, and the skilled worker needs the effective concentration level of “5”, the effective fatigue level of “8”, and the effective stress level of “4”. For the assembly work, it is shown that the new worker needs the effective concentration level of “7”, the effective fatigue level of “2”, and the effective stress level of “4”, the mid-level worker needs the effective concentration level of “5”, the effective fatigue level of “4”, and the effective stress level of “2”, and the skilled worker needs the effective concentration level of “5”, the effective fatigue level of “5”, and the effective stress level of “1”. Further, for the picking work, it is shown that the new worker needs the effective concentration level of “4”, the effective fatigue level of “7”, and the effective stress level of “3”, the mid-level worker needs the effective concentration level of “3”, the effective fatigue level of “8”, and the effective stress level of “1”, and the skilled worker needs the effective concentration level of “2”, the effective fatigue level of “8”, and the effective stress level of “1”. Furthermore, for the inventory work, it is shown that the new worker needs the effective concentration level of “2”, the effective fatigue level of “6”, and the effective stress level of “2”, the mid-level worker needs the effective concentration level of “1”, the effective fatigue level of “7”, and the effective stress level of “1”, and the skilled worker needs the effective concentration level of “1”, the effective fatigue level of “8”, and the effective stress level of “1”.

As exemplarily shown in FIG. 13, it can be seen that the mental and physical condition which produces an effect is different depending on the work, for example, the effect of the effective concentration level is larger on the inspection work than the other works (in other words, the inspection work requires high effective concentration level of the worker), the effect of the effective fatigue level is larger on the assembly work than the other works (in other words, the assembly work requires a state in which the effective fatigue level of the worker is low), further the effect of the effective stress level is larger on the inventory work than the other works (in other words, the inventory work requires a state in which the effective stress level of the worker is low), and the like.

In the above-described exemplary case, for example, in a case where the effective fatigue level of the new worker A who is performing the assembly work is “1”, since this satisfies the condition of the effective fatigue level required for this work, which is not higher than “2”, the work assignment unit 106 may instruct the new worker A to continue this work.

Herein, in condition determination using the effective fatigue level and the effective stress level, when the current effective fatigue level and the current effective stress level are not higher than the effective fatigue level and the effective stress level which are required for each work, respectively, it is determined that the condition for doing the work is satisfied.

Specifically, when the work assignment unit 106 generates the work assignment information, the work assignment unit 106 may select the mental and physical condition which affects most the target work, to thereby generate the work assignment information.

Further, even when the mental and physical condition which affects most the target work satisfies the condition for doing the work, if at least one of the other mental and physical conditions unsatisfies the condition for the work significantly (for example, by 50% or more), the work assignment unit 106 may generate the work assignment information for instructing the worker to change the work.

In the above-described case, when the effective concentration level of the new worker A who is doing the assembly work is “3” and the effective fatigue level thereof is “1”, though an instruction to continue the work can be given since the effective fatigue level which affects most the work satisfies the condition of not higher than “2”, an instruction to change the specifics of the work may be given since the effective concentration level of the new worker A, which is “3”, falls short of the effective concentration level of “7” required for the assembly work by 50% or more.

At that time, a work which is a candidate of the change destination may be selected with the best mental and physical condition among the estimated mental and physical conditions of the worker, as the reference.

In the above-described case, when the effective concentration level of the new worker A who is doing the assembly work is “3”, the effective fatigue level thereof is “1”, and the effective stress level thereof is “4”, it is determined that the effective fatigue level is in the best level as the mental and physical condition of the new worker A,

Herein, the mental and physical condition is “in a good level” when the effective concentration level has a high value or the effective fatigue level or the effective stress level has a low value.

Among the above-described cases, in a case where it is determined that the assembly work cannot be continued since the effective fatigue level satisfies the condition but the effective concentration level falls short of the condition by 50% or more among the conditions required for this work, the inspection work and the inventory work (the condition of the effective fatigue level required for both works is “6”), in which the required effective fatigue level is not lower than “1” and the required effective fatigue level is closest to “1”, can be selected as a candidate of the change destination work.

As to the inspection work, the condition of the required effective concentration level is “9” or more. Therefore, since the current effective concentration level of the new worker A, which is “3”, falls short of the condition by 50% or more, the inspection work is not suitable for the change destination work.

In contrast to this case, as to the inventory work, the condition of the required effective concentration level is “2” or more and the current effective concentration level of the new worker A, which is “3”, satisfies this condition. Further, the condition of the effective stress level required for the inventory work is “8” or less and the current effective stress level of the new worker A, which is “4”, also satisfies this condition. Therefore, it is determined that the inventory work is appropriate as the change destination work.

Further, when the condition of the inventory work is not satisfied, the picking work is selected as the change destination work, in which the required effective fatigue level is not lower than that in the inventory work. Then, in a case where the effective concentration level and the effective stress level satisfy the respective conditions or do not fall short of the respective conditions by 50% or more, an instruction to change the work to the picking work is given.

On the other hand, when there is no candidate of the change destination work, the break instruction may be given.

The notification unit 107 in the configuration of FIG. 1 notifies the manager about the work assignment information generated by the work assignment unit 106. This notification is achieved by performing message notification on a display monitor connected to a computer terminal of the manager.

Further, since the message notification cannot be received while the manager is doing a work, away from a predetermined position, the message notification may be given to a terminal such as a smartphone, a tablet, or the like that the manager wears. Furthermore, by installing the display monitor or the tablet at a place where each production process is performed, the message notification may be given to not only the manager but also the worker at the same time.

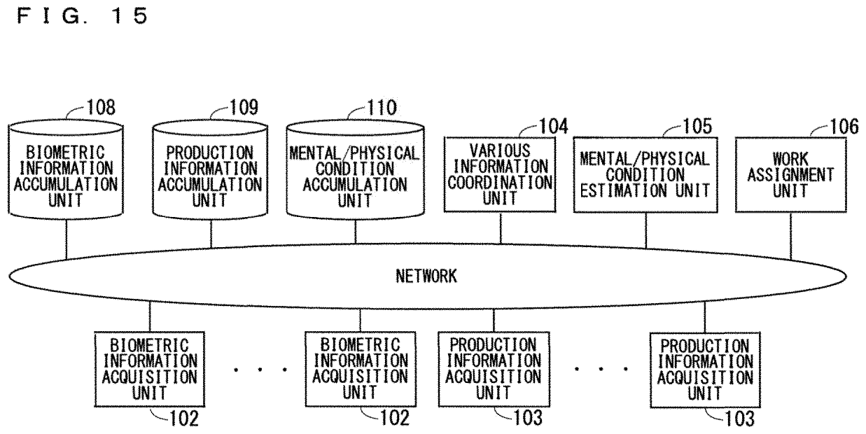

FIG. 14 is a diagram schematically showing an exemplary hardware configuration in a case where the work assignment device in accordance with the present preferred embodiment is actually operated. In FIG. 14, particularly shown is an exemplary hardware configuration of a computer terminal for implementing the production information acquisition unit 103, the various information coordination unit 104, the mental/physical condition estimation unit 105, and the work assignment unit 106.

Further, there is a case where the number of constituent elements or the like in the hardware configuration illustrated in FIG. 14 does not conform with that in the configuration illustrated in FIG. 1, and this is because the constituent element illustrated in FIG. 1 represents a conceptual unit.

Therefore, there are at least possible cases where one constituent element illustrated in FIG. 1 consists of a plurality of hardware constituent elements illustrated in FIG. 14, where one constituent element illustrated in FIG. 1 corresponds to part of the hardware constituent element illustrated in FIG. 14, and where a plurality of constituent elements illustrated in FIG. 1 are included in one hardware constituent element illustrated in FIG. 14.

Further, the hardware configuration in FIG. 14 specifically illustrates the conceptual configuration of the work assignment device illustrated in FIG. 1. Therefore, in FIG. 14, though there is a case where a new hardware constituent element is added to the hardware configuration corresponding to the conceptual configuration of the work assignment device illustrated in FIG. 1, even when the newly added hard constituent element is not included, the work assignment device in accordance with the present preferred embodiment can be implemented.

The computer terminal shown in FIG. 14 includes a keyboard 1201 and a mouse 1202 each serving as an input device for inputting information, a microprocessor 1203 serving as an arithmetic unit, a Hard Disk Drive (HDD) 1204, a Random Access Memory (RAM) 1205, a Read Only Memory (ROM) 1206, a graphic chip 1207, and a frame buffer 1208 each serving as a memory device, and a display monitor 1209 serving as an output device for outputting information.

Further, the arithmetic unit includes, for example, a central processing unit (CPU), a microcomputer, a digital signal processor (DSP), or the like. Furthermore, the arithmetic unit may execute a program stored in the memory device or the like.

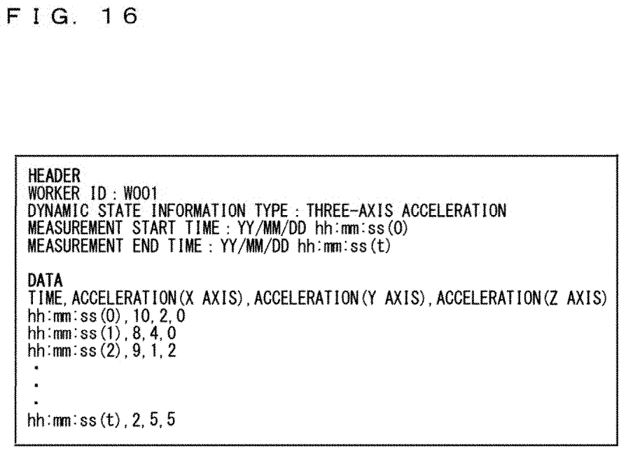

FIG. 15 is a diagram showing an exemplary network configuration of the work assignment device in accordance with the present preferred embodiment. Herein, the notification unit 107 is included in the computer terminal which corresponds to the work assignment unit 106.

As exemplarily shown in FIG. 15, all the constituent elements in the work assignment device are connected to one another via a network. The biometric information acquisition unit 102, however, may be connected to the network, corresponding to the number of workers, through the smartphones, the tablets, or the like which the workers wear.

The biometric information acquisition unit 102 may be connected to the smartphone, the tablet terminal, or the like which the worker wears via, for example, 3G mobile communication, 4G mobile communication, Bluetooth (registered trademark), or the like.

Further, the mental/physical condition estimation unit 105, the biometric information accumulation unit 108, the production information accumulation unit 109, and the mental/physical condition accumulation unit 110 may be connected to one another via an external network. In this case, the estimation of the mental and physical condition can be performed at an in-house data center which is established at a site away from the factory or by using cloud computing of other company, or the like.

In the factory, a new worker W (worker ID of “W001”) who is doing the assembly work of a product “P001” is made to wear a glass-type wearable device.

The biometric information which can be acquired by the glass-type wearable device as the biometric information acquisition unit 102 is the nictation rate and for example, the nictation rate for the most recent one minute is acquired every five seconds. Then, the biometric information acquisition unit 102 transmits the biometric information to the biometric information accumulation unit 108.

On the other hand, the production information acquisition unit 103 acquires a working time that it takes to perform assembly of one product “P001”. Then, the production information acquisition unit 103 transmits the production information to the production information accumulation unit 109.

The various information coordination unit 104 acquires the time-series data of the most recent 30 minutes every one cycle (for example, one minute) from the biometric information accumulation unit 108 and the production information accumulation unit 109.

The mental/physical condition estimation unit 105 estimates the mental and physical condition of the worker in accordance with the procedure exemplarily shown in FIG. 5.

Then, the mental/physical condition estimation unit 105 calculates an average value [times/minute] (herein, assumed to be 10) of the biometric information (herein, the nictation rate) out of the time-series data acquired from the various information coordination unit 104. Then, the mental/physical condition estimation unit 105 compares the calculated average value (herein, 10) with an average value [times/minute] (herein, assumed to be 20) at a normal time.

Then, the mental/physical condition estimation unit 105 calculates the concentration level (herein, 7) on the basis of a comparison result indicating that the average value of the biometric information calculated from the time-series data acquired from the various information coordination unit 104 is reduced from the average value at a normal time by 50%. Herein, the concentration level at a normal time is set to be “5”.

Since the calculated concentration level “7” is larger than the concentration level “5” at a normal time, the work efficiency is calculated by comparing the production information (the working time per machine) with the threshold value.

The mental/physical condition estimation unit 105 calculates an average value [seconds] (the average working time per machine: herein assumed to be 8.5) of the production information (the working time) out of the time-series data acquired from the various information coordination unit 104. Then, the mental/physical condition estimation unit 105 compares the calculated average value with an average value [seconds] (herein, assumed to be 5) in the same work for the most recent one week.

Then, the mental/physical condition estimation unit 105 calculates the work efficiency (herein, assumed to be 2) on the basis of a comparison result indicating that the calculated average value is increased from the average value in the same work for the most recent one week by 70%. Herein, the work efficiency at a normal time (an average value in the same work for the most recent one week) is set to be “5”.

Finally, the mental/physical condition estimation unit 105 calculates out an average value, i.e., “4.5” of the concentration level “7” estimated from the biometric information and the work efficiency “2”, and transmits this value to the mental/physical condition accumulation unit 110 as the effective concentration level.

The work assignment unit 106 acquires the most recent mental and physical condition of the new worker W from the mental/physical condition accumulation unit 110 every one cycle (for example, 30 minutes) set by the manager. Then, the work assignment unit 106 generates the work assignment information, for example, for assigning the inventory work in which the required effective concentration level is “2” to the new worker W on the basis of the acquired effective concentration level of “4.5” and the condition of the effective concentration level corresponding to the proficiency required for each work, for example, exemplarily shown in FIG. 12. Then, the work assignment unit 106 transmits this information to the notification unit 107.

The notification unit 107 notifies the computer terminal of the manager about the work assignment information acquired from the work assignment unit 106.

Thus, according to the present preferred embodiment, it becomes possible to improve estimation accuracy of the mental and physical condition by estimating the mental and physical condition of the worker by using the biometric information of the worker and the production information of the plant facilities.

Further, according to the present preferred embodiment, since the work suitable for the mental and physical condition of the worker can be assigned to the worker on the basis of the estimation result of the mental and physical condition of the worker, it becomes possible to ensure an increase in the efficiency of the work.

### The Second Preferred Embodiment

A work assignment device and a work assignment method in accordance with the present preferred embodiment will be described. In the following description, constituent elements identical to those shown in the above-described preferred embodiment are represented by the same reference signs and detailed description thereof will be omitted as appropriate.

In the work assignment device of the present preferred embodiment, since a hardware configuration of the computer terminal, a network configuration, or the like is the same as that in the above-described first preferred embodiment, detailed description thereof will be herein omitted. In the present preferred embodiment, differences from the first preferred embodiment will be mainly described.

<Configuration of Work Assignment Device>

In the present preferred embodiment, the biometric information acquisition unit 102 further acquires dynamic state information such as acceleration (moving acceleration) generated for moving or the like, three-axis acceleration, a movement route, a residence time, position information of the worker, or the like, additionally to the biometric information of the worker described in the above-described first preferred embodiment. The dynamic state information is acquired by using the wearable device that the worker wears, but may be acquired by using an acceleration sensor, GPS, or the like which is incorporated in the smartphone or the tablet.

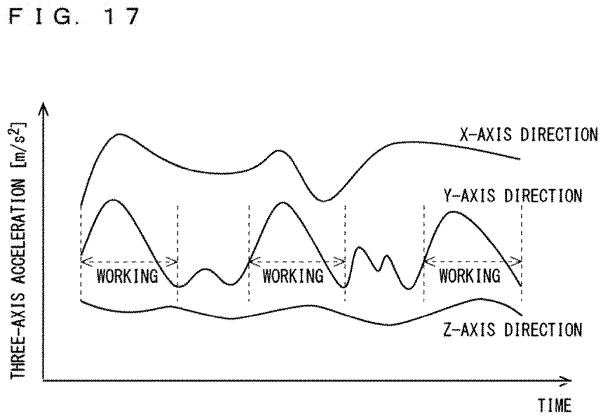

FIG. 16 is a diagram showing an example of the dynamic state information of the worker which is acquired by the biometric information acquisition unit 102. Further, x axis, y axis, and z axis in FIG. 16 correspond to an axis in a horizontal direction, an axis in a horizontal direction orthogonal to the x axis, and an axis in a vertical direction, respectively.

As exemplarily shown in FIG. 16, in the dynamic state information, stored are a header part including a worker ID unique to each worker, a dynamic state information type indicating the type of the acquired dynamic state information, a measurement start time indicating the start date and time of the measurement, a measurement end time indicating the end date and time of the measurement, and the like and a data part including numerical information of the acquired dynamic state information (a measured value) and the like.

By acquiring and analyzing the above-described dynamic state information of the worker, it becomes possible to determine whether or not the worker is doing a work in which the worker should be engaged, or the like.

In a case, for example, where the position of a process in which the worker should be engaged, in the factory, is (x, y) and the position information of the worker indicates (x±5, y±5), it can be determined that the worker is doing a work different from the work in which the worker should be originally engaged. Further, it is possible to determine whether or not the worker is doing a work in which the worker should be engaged by using the acceleration and the three-axis acceleration, instead of the position information.

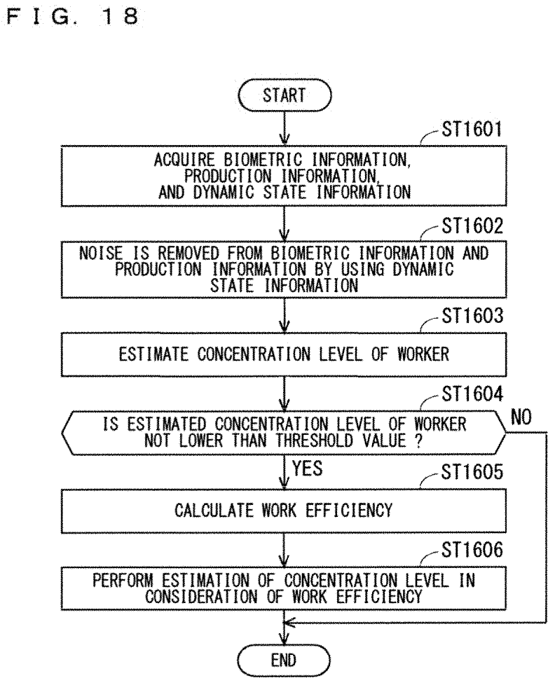

FIG. 17 is a graph showing an exemplary case where determination on whether the worker is working or not is performed by using the three-axis acceleration acquired from the worker. In FIG. 17, the vertical axis indicates the three-axis acceleration [m/s²] and the horizontal axis indicates the time. Further, x axis, y axis, and z axis in FIG. 17 correspond to an axis in the horizontal direction, an axis in the horizontal direction orthogonal to the x axis, and an axis in the vertical direction, respectively.

The work that the worker does is done in accordance with a procedure which is determined in advance by work instruction or the like. For this reason, the three-axis acceleration on which body movement of the worker is reflected is changed at a regular cycle while the worker is working.

In the exemplary case of FIG. 17, it can be seen that the acceleration in a y-axis direction is changed at a regular cycle. Then, it can be determined that a periodic change in the acceleration in the y-axis direction indicates that the worker is working.

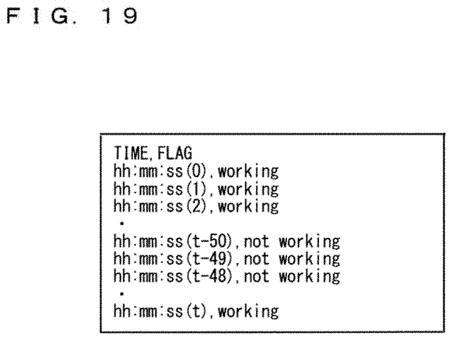

FIG. 18 is a flowchart showing an exemplary procedure for estimating the mental and physical condition of the worker by using the mental/physical condition estimation unit 105.

First, the mental/physical condition estimation unit 105 acquires the biometric information, the production information, and further the dynamic state information which are time-series data from the various information coordination unit 104 (Step ST1601). Further, the various information coordination unit 104 generates the time-series data associated with the worker ID in advance by using the biometric information, the production information, and the dynamic state information.

Next, the mental/physical condition estimation unit 105 removes a noise from the biometric information and the production information which are acquired in Step ST1601 by using the dynamic state information of the worker (Step ST1602).

Specifically, the mental/physical condition estimation unit 105 determines whether or not the worker is doing the work in which the worker should be engaged by using the dynamic state information of the worker (for example, determines if the worker is walking to move, instead of working, on the basis of the acceleration). Then, the mental/physical condition estimation unit 105 removes the noise from the biometric information and the production information which are acquired from the various information coordination unit 104.

FIG. 19 is a diagram showing an exemplary result obtained by performing noise determination of the biometric information and the production information by using the dynamic state information of the worker.

As exemplarily shown in FIG. 19, the mental/physical condition estimation unit 105 determines whether or not the worker is doing the work in which the worker should be engaged, by analyzing a waveform of the three-axis acceleration acquired from the worker. Then, the mental/physical condition estimation unit 105 generates a flag indicating “working” when the worker is working and otherwise generates another flag indicating “not working”, together with the time information.

Next, the mental/physical condition estimation unit 105 estimates the concentration level of the worker by using only the biometric information among the biometric information and the production information which are noise-removed (Step ST1603). Specifically, the mental/physical condition estimation unit 105 estimates the concentration level of the worker by using only the biometric information corresponding to the flag of “working” in FIG. 19.

Next, the mental/physical condition estimation unit 105 determines whether or not the estimated concentration level of the worker is not lower than the threshold value (Step ST1604).

When the estimated concentration level of the worker is not lower than the threshold value, in other words, when this situation corresponds to “YES” branching from Step ST1604 exemplarily shown in FIG. 18, it is determined that the concentration level of the worker is high, and the process goes to Step ST1605.

On the other hand, when the estimated concentration level of the worker is lower than this threshold value, in other words, when this situation corresponds to “NO” branching from Step ST1604 exemplarily shown in FIG. 18, it is determined that the concentration level of the worker is low. Then, the mental/physical condition estimation unit 105 transmits the estimated concentration level of the worker to the mental/physical condition accumulation unit 110, and this operation is ended.

Next, in Step ST1605, the mental/physical condition estimation unit 105 calculates the work efficiency by comparing the production information of the work that the worker is doing with the threshold value.

Next, the mental/physical condition estimation unit 105 performs an estimation of the concentration level (the effective concentration level) in consideration of the work efficiency of the worker (Step ST1606).

Herein, when the above-described noise removal is not performed, in a case, for example, where the worker goes away from the production process by a direction of the manager, if the mental and physical condition is estimated by using the biometric information and the production information during this time period, there is a possibility that the effective concentration level of the worker may be estimated to be low.

In contrast to this case, when data at a time of “not working” is removed from the biometric information and the production information by using the dynamic state information of the worker as described above and the mental and physical condition of the worker is estimated on the basis of the biometric information and the production information after being subjected to the noise removal, it is possible to improve the estimation accuracy of the mental and physical condition of the worker.

### The Third Preferred Embodiment

A work assignment device, a work assignment system, and a work assignment method in accordance with the present preferred embodiment will be described. In the following description, constituent elements identical to those shown in the above-described preferred embodiments are represented by the same reference signs and detailed description thereof will be omitted as appropriate. Also in the present preferred embodiment, differences from the first and second preferred embodiments will be mainly described.

<Configuration of Work Assignment Device>

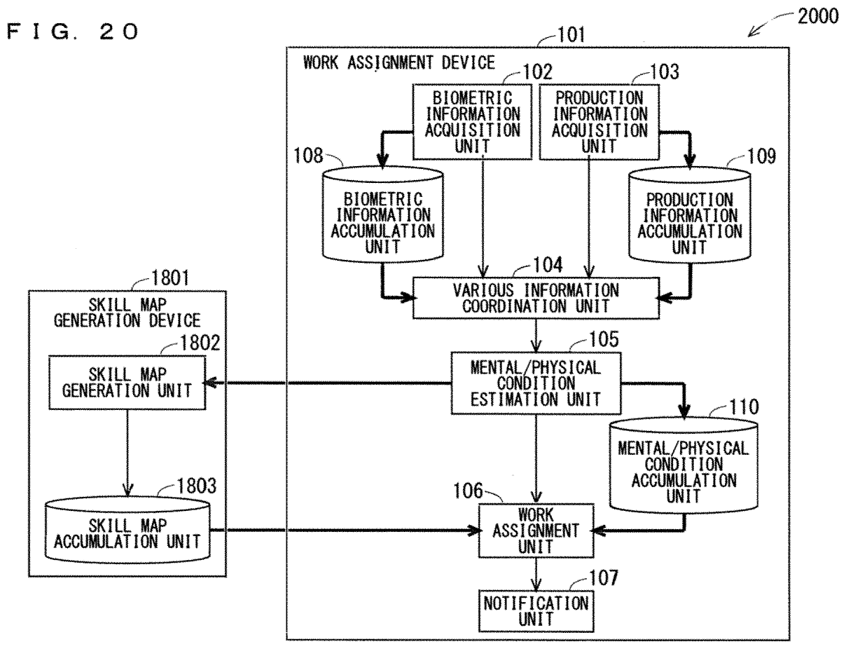

FIG. 20 is a diagram conceptually showing an exemplary configuration of the work assignment device and an exemplary configuration of the work assignment system including a skill map generation device in accordance with the present preferred embodiment.

As exemplarily shown in FIG. 20, a work assignment system 2000 includes the work assignment device 101 and a skill map generation device 1801.

Among these devices, the work assignment device 101 includes the biometric information acquisition unit 102, the production information acquisition unit 103, the various information coordination unit 104, the mental/physical condition estimation unit 105, the work assignment unit 106, the notification unit 107, the biometric information accumulation unit 108, the production information accumulation unit 109, and the mental/physical condition accumulation unit 110.

On the other hand, the skill map generation device 1801 includes a skill map generation unit 1802 and a skill map accumulation unit 1803.

The skill map generation unit 1802 in the configuration of FIG. 20 acquires the estimation result of the mental and physical condition of the worker from the mental/physical condition estimation unit 105. Then, the skill map generation unit 1802 estimates a temporal change in the mental and physical condition of the worker due to continuation of the work and generates temporal change information indicating the temporal change. Then, the skill map generation unit 1802 transmits the temporal change information to the skill map accumulation unit 1803.

Further, the skill map generation unit 1802 acquires the estimation result of the mental and physical condition of the worker from the mental/physical condition estimation unit 105 immediately after the mental/physical condition estimation unit 105 estimates the mental and physical condition of the worker.

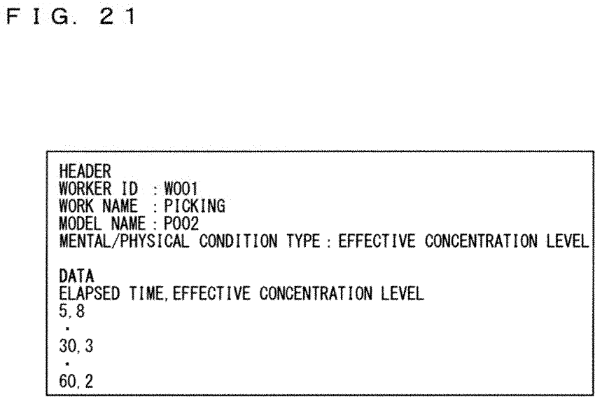

FIG. 21 is a diagram showing an example of the temporal change information of the mental and physical condition (herein, the effective concentration level) of the worker, which is generated by the skill map generation unit 1802.

As exemplarily shown in FIG. 21, in the temporal change information of the mental and physical condition of the worker, stored are a header part including a worker ID unique to each worker, a work name indicating the specifics of the work, a model name indicating a machine model which is to be operated, a mental/physical condition type indicating the type of the mental and physical condition, and the like and a data part including numerical information (an estimated value) of the mental and physical condition and the like.

Further, the cycle of acquiring the numerical information (the estimated value) of the mental and physical condition can be arbitrarily set by the manager. Furthermore, since an elapsed time from the acquisition of the numerical information (the estimated value) can be obtained if the cycle of acquiring the numerical information (the estimated value) of the mental and physical condition is constant, the cycle of acquiring the numerical information (the estimated value) may be described in the header part.

Further, in the exemplary case of FIG. 21, shown are changes in the effective concentration level every five minutes while the worker having the worker ID of “W001” was doing the picking work of a product “P002” in the past.

The skill map accumulation unit 1803 acquires and accumulates the temporal change information of the mental and physical condition of the worker, which is generated by the skill map generation unit 1802.

The work assignment unit 106 acquires the time-series data of the most recent mental and physical condition of the worker, which is accumulated in the mental/physical condition accumulation unit 110. At the same time, the work assignment unit 106 acquires the temporal change information of the past mental and physical condition of the worker from the skill map accumulation unit 1803.

Then, the work assignment unit 106 generates the work assignment information for ensuring an increase in the efficiency of the work by using two types of acquired data (the time-series data of the mental and physical condition of the worker and the temporal change information of the mental and physical condition of the worker).

In a case, for example, where the most recent effective concentration level of the new worker W (worker ID of “W001”) who is engaged in the assembly work of the product “P001” is “6”, the work assignment information for assigning the picking work (in which the condition of the required effective concentration level is “5”) in which the condition of the required effective concentration level is not higher than “6” and closest to “6” to the new worker W and instructing the new worker W to do the work for one hour has been generated so far by using the condition of the effective concentration level required for each work as shown in FIG. 12.

Herein, however, the work assignment unit 106 generates the work assignment information in consideration of the effective concentration level of “3” at a point in time when 30 minutes elapse after starting the work, by using the temporal change information of the past mental and physical condition as exemplarily shown in FIG. 21.

In the above-described case, since it is determined that it is difficult for the new worker W to continue the picking work for one hour, the work assignment unit 106 generates the work assignment information for assigning the inventory work in which the condition of the required effective concentration level is lower than that of the picking work to the new worker W.

Thus, by generating the work assignment information in consideration of the temporal change in the past mental and physical condition additionally to the condition of the effective concentration level required for each work, it is possible to perform efficient work assignment. Then, as a result, it is possible to ensure an improvement in the work efficiency.

### Effects Produced by the Above-Described Preferred Embodiments

Next, exemplary effects produced by the above-described preferred embodiments will be described. In the following description, though the effects will be described on the basis of the specific configurations exemplarily shown in the above-described preferred embodiments, the configurations may be replaced by any other specific configuration exemplarily shown in the present specification within the scope where the same effects can be produced.

Further, this replacement may be made across the plurality of preferred embodiments. In other words, the respective configurations exemplarily shown in the different preferred embodiments may be combined to produce the same effects.

According to the above-described preferred embodiments, the work assignment device includes the biometric information acquisition unit 102, the production information acquisition unit 103, a time-series data generation unit, the mental/physical condition estimation unit 105, and the work assignment unit 106. Herein, the time-series data generation unit corresponds to, for example, the various information coordination unit 104. The biometric information acquisition unit 102 is a wearable device that is wearable on a body of a worker. The biometric information acquisition unit 102 acquires the biometric information on a living body of the worker. The production information acquisition unit 103 acquires the production information on a work record of the worker. The various information coordination unit 104 acquires the time-series data associating each worker with the biometric information and the production information. The mental/physical condition estimation unit 105 estimates the mental and physical condition of the worker (for example, the concentration level of the worker to the work, the fatigue level of the worker, the stress level of the worker, the sleepiness of the worker, or the like) on the basis of the time-series data. The work assignment unit 106 assigns a work to the worker on the basis of the estimated mental and physical condition of the worker.

Further, according to the above-described preferred embodiments, the work assignment device includes the microprocessor 1203 serving as a processing circuit for executing a program and the memory device for storing the program to be executed (for example, the HDD 1204, the RAM 1205, the ROM 1206, or the like). Then, the processing circuit executes the program, to thereby implement the following operations.

Specifically, the time-series data associating each worker with the biometric information on the living body of the worker and the production information on the work record of the worker are generated. Then, the mental and physical condition of the worker is estimated on the basis of the time-series data. Then, a work is assigned to the worker on the basis of the estimated mental and physical condition of the worker.

Further, according to the above-described preferred embodiments, the work assignment device includes a processing circuit which is dedicated hardware. The processing circuit which is dedicated hardware performs the following operations.

Specifically, the processing circuit which is dedicated hardware generates the time-series data associating each worker with the biometric information on the living body of the worker and the production information on the work record of the worker. Then, the processing circuit which is dedicated hardware estimates the mental and physical condition of the worker on the basis of the time-series data. Then, the processing circuit which is dedicated hardware assigns a work to the worker on the basis of the estimated mental and physical condition of the worker.

According to such a configuration, in consideration of the biometric information of the worker and the production information on the work record of the worker, the effective mental and physical condition of the worker (i.e., an effective index for the worker to do a work) is estimated, and further the work is assigned to the worker on the basis of the mental and physical condition of the worker, which is estimated thus. Therefore, it is possible to uniformize the work as compared with the case where the work is assigned to the worker on the basis of the mental and physical condition estimated only from the biometric information, and to achieve appropriate personal distribution.

Further, even in a case where at least one of the other constituent elements exemplarily shown in the specification of the present application is added to the above-described constituent elements as appropriate, i.e., in a case where any other constituent element exemplarily shown in the specification of the present application, which has not been described as the above-described constituent elements, is added to the above-described constituent elements as appropriate, the same effects can be also produced.

Further, according to the above-described preferred embodiments, when the biometric information indicates a first threshold value or more, the mental/physical condition estimation unit 105 estimates the mental and physical condition of the worker on the basis of the time-series data. According to such a configuration, when the biometric information does not indicate a desired value, the information can be removed as a noise and therefore the estimation accuracy of the mental and physical condition is improved.

Furthermore, according to the above-described preferred embodiments, the mental/physical condition estimation unit 105 calculates the work efficiency of the worker by comparing the production information with a second threshold value which varies depending on the proficiency of the worker, and further estimates the mental and physical condition of the worker by using the biometric information and the work efficiency. According to such a configuration, since the effective mental and physical condition of the worker can be estimated in consideration of the work efficiency of the worker, it is possible to uniformize the work as compared with the case where the work is assigned to the worker on the basis of the mental and physical condition estimated only from the biometric information, and to achieve appropriate personal distribution.

Further, according to the above-described preferred embodiments, the biometric information includes information on a heart rate, a pulse rate, a nictation rate, an ocular potential, a line of sight, a body surface temperature, a core body temperature, a blood pressure, a respiration rate, a sweat rate, or a skin potential of the worker. According to such a configuration, it is possible to reflect the condition of the worker on the work assignment.

Furthermore, according to the above-described preferred embodiments, the production information includes information on the cumulative number of works, the average number of works, the number of reworks, or a defect rate of the worker. According to such a configuration, it is possible to reflect the work record of the worker on the work assignment.

Further, according to the above-described preferred embodiments, the mental/physical condition estimation unit 105 estimates the mental and physical condition of the worker while the worker is working. According to such a configuration, by estimating the mental and physical condition of the worker in real time, it is possible to quickly perform work assignment on the basis of the mental and physical condition of the worker. Since the change in the mental and physical condition during the work is instantly reflected on the work assignment, the work efficiency of the worker can be increased.

Furthermore, according to the above-described preferred embodiments, the biometric information acquisition unit 102 acquires the dynamic state information of the worker. Then, the various information coordination unit 104 generates the time-series data associating each worker with the biometric information, the production information, and the dynamic state information. According to such a configuration, in a case, for example, where the worker is engaged in the work immediately after moving up or down a staircase or the like case, i.e., a case where a sharp change in the biometric information is anticipated to occur, the noise of the biometric information can be removed on the basis of the dynamic state information. Therefore, the estimation accuracy of the mental and physical condition of the worker can be improved.

Further, according to the above-described preferred embodiments, the mental/physical condition estimation unit 105 determines whether or not the worker is doing a work on the basis of the dynamic state information. Then, the mental/physical condition estimation unit 105 estimates the mental and physical condition of the worker on the basis of the time-series data at the time when the worker is doing a work. According to such a configuration, it is possible to remove the noise of the biometric information and the noise of the production information at the time when the worker is not doing a work, on the basis of the dynamic state information. Therefore, the estimation accuracy of the mental and physical condition of the worker can be improved.

Furthermore, according to the above-described preferred embodiments, the dynamic state information includes information on moving acceleration of the worker, a movement route of the worker, or the position of the worker. According to such a configuration, it is possible to comprehend whether or not the worker is doing a work, whether or not such a movement as to cause a sharp change in the biometric information of the worker is made, or the like.

Further, according to the above-described preferred embodiments, the work assignment system 2000 includes the above-described work assignment device 101 and a temporal change estimation unit. Herein, the temporal change estimation unit corresponds to, for example, the skill map generation unit 1802. The skill map generation unit 1802 estimates the temporal change in the mental and physical condition of the worker on the basis of the estimated mental and physical condition of the worker. The work assignment unit 106 assigns a work to the worker on the basis of the estimated mental and physical condition of the worker and the estimated temporal change in the mental and physical condition of the worker. According to such a configuration, by estimating the temporal change in the mental and physical condition of the worker, it is possible to reflect the change in the mental and physical condition of the worker, which may be caused by continuation of the work, on the work assignment.

Furthermore, according to the above-described preferred embodiments, in the work assignment method, the time-series data associating each worker with the biometric information on the living body of the worker and the production information on the work record of the worker are generated, the mental and physical condition of the worker is estimated on the basis of the time-series data, and a work is assigned to the worker on the basis of the estimated mental and physical condition of the worker.

According to such a configuration, the effective mental and physical condition of the worker is estimated in consideration of the biometric information of the worker and the production information on the work record of the worker, and further a work is assigned to the worker on the basis of the mental and physical condition of the worker which is estimated thus. Therefore, it is possible to uniformize the work as compared with the case where the work is assigned to the worker on the basis of the mental and physical condition estimated only from the biometric information, and to achieve appropriate personal distribution.

Further, even in a case where at least one of the other constituent elements exemplarily shown in the specification of the present application is added to the above-described constituent elements as appropriate, i.e., in a case where any other constituent element exemplarily shown in the specification of the present application, which has not been described as the above-described constituent elements, is added to the above-described constituent elements as appropriate, the same effects can be also produced.

Furthermore, unless there is no particular limitation, the order of performing respective processes may be changed.

### Variations of the Above-Described Preferred Embodiments

In the preferred embodiments described above, the material quality, material, size, shape, relative arrangement relation, implementation condition, or the like of each constituent element are described in some cases, but these are only examples in all aspects and not limited to those described in the present specification.

Therefore, an indefinite number of modifications, variations, and equivalents not exemplarily shown are assumed within the scope of the technique disclosed in the present specification. These modifications, variations, and equivalents include, for example, exemplary cases where at least one constituent element is deformed, added, and/or omitted, and further where at least one constituent element in at least one preferred embodiment is extracted and combined with a constituent element in any other preferred embodiment.

Further, in the above-described preferred embodiments, when it is described that something comprises “a” constituent element, something may comprise “one or more” constituent elements, as long as no contradiction arises.

Furthermore, each constituent element in the above-described preferred embodiments is a conceptual unit, and the scope of the technique disclosed in the present specification includes cases where one constituent element is constituted of a plurality of structural objects, where one constituent element corresponds to part of a structural object, and further where a plurality of constituent elements are included in one structural object.

Further, each constituent element in the above-described preferred embodiment includes any structural object having any other structure or shape, as long as it can perform the same function.

Furthermore, the description in the present specification can be referred to for all purposes pertaining to the present technique, and is not recognized as the prior art.

Further, each constituent element in the above-described preferred embodiments can be assumed as software or firmware, or as hardware corresponding thereto, and the constituent element is referred to as a “unit”, a “processing circuit”, or the like in both the concepts.

### EXPLANATION OF REFERENCE SIGNS

101 work assignment device, 102 biometric information acquisition unit, 103 production information acquisition unit, 104 various information coordination unit, 105 mental/physical condition estimation unit, 106 work assignment unit, 107 notification unit, 108 biometric information accumulation unit, 109 production information accumulation unit, 110 mental/physical condition accumulation unit, 1201 keyboard, 1202 mouse, 1203 microprocessor, 1204 HDD, 1205 RAM, 1206 ROM, 1207 graphic chip, 1208 frame buffer, 1209 display monitor, 1801 skill map generation device, 1802 skill map generation unit, 1803 skill map accumulation unit, 2000 work assignment system

1. A work assignment device comprising:
at least one first processor to execute a first program; and
at least one first memory to store the first program which, when it is executed by the first processor, causes the first processor to perform first processes comprising:
acquiring biometric information on a living body of a worker;
acquiring production information on a work record of the worker;
generating time-series data associating each worker with the biometric information and the production information;
estimating a mental and physical condition of the worker on the basis of the time-series data; and
assigning a work to the worker on the basis of the estimated mental and physical condition of the worker.

2. The work assignment device according to claim 1, wherein
estimating the mental and physical condition of the worker comprises estimating the mental and physical condition of the worker on the basis of the time-series data when the biometric information indicates a first threshold value or more.

3. The work assignment device according to claim 1, wherein
estimating the mental and physical condition of the worker comprises calculating work efficiency of the worker by comparing the production information with a second threshold value which varies depending on the proficiency of the worker, and further estimating the mental and physical condition of the worker by using the biometric information and the work efficiency.

4. The work assignment device according to claim 1, wherein
the biometric information includes information on a heart rate, a pulse rate, a nictation rate, an ocular potential, a line of sight, a body surface temperature, a core body temperature, a blood pressure, a respiration rate, a sweat rate, or a skin potential of the worker.

5. The work assignment device according to claim 1, wherein
the production information includes information on the cumulative number of works, the average number of works, the number of reworks, or a defect rate of the worker.

6. The work assignment device according to claim 1, wherein
estimating the mental and physical condition of the worker comprises estimating the mental and physical condition of the worker while the worker is working.

7. The work assignment device according to claim 1, wherein
acquiring the biometric information comprises further acquiring dynamic state information of the worker, and
generating the time-series data comprises generating the time-series data associating each worker with the biometric information, the production information, and the dynamic state information.

8. The work assignment device according to claim 7, wherein
estimating the mental and physical condition of the worker comprises determining whether or not the worker is doing the work on the basis of the dynamic state information, and further estimating the mental and physical condition of the worker on the basis of the time-series data when the worker is doing the work.

9. The work assignment device according to claim 7, wherein
the dynamic state information includes information on a moving acceleration of the worker, a movement route of the worker, or a position of the worker.

10. A work assignment system comprising:
at least one second processor to execute a second program; and
at least one second memory to store the second program which, when it is executed by the second processor, causes the second processor to perform second processes comprising:
assigning a work to the worker using the work assignment device according to claim 1; and
estimating a temporal change in the mental and physical condition of the worker on the basis of the estimated mental and physical condition of the worker,
wherein assigning a work to the worker comprises assigning a work to the worker on the basis of the estimated mental and physical condition of the worker and the estimated temporal change in the mental and physical condition of the worker.

11. A work assignment method, comprising:
generating time-series data associating each worker with biometric information on a living body of a worker and production information on a work record of the worker;
estimating a mental and physical condition of the worker on the basis of the time-series data; and
assigning a work to the worker on the basis of the estimated mental and physical condition of the worker.

12. The work assignment method according to claim 11, including
estimating the mental and physical condition of the worker while the worker is working.

13. The work assignment method according to claim 11, including:
generating the time-series data associating each worker with the biometric information, the production information, and dynamic state information of the worker;
determining whether or not the worker is doing the work on the basis of the dynamic state information; and
further estimating the mental and physical condition of the worker on the basis of the time-series data in a case where the worker is doing the work.
